(19) United States
(12) Patent Application Publication
(10) Pub. No.: US 2008/0144085 A1
(43) Pub. Date: Jun. 19, 2008

(54) Method Of Transmitting/Receiving Facsimile Data Through Internet And System Thereof

(75) Inventor: Min-Jae Song, Seoul (KR)

Correspondence Address: CANTOR COLBURN, LLP, 20 Church Street, 22nd Floor, Hartford, CT, 06103, US

(73) Assignee: KICOM CO., LTD., Seoul (KR)

(21) Appl. No.: 11/722,467

(22) PCT Filed: Dec. 30, 2005
(86) PCT No.: PCT/KR2005/004656

§ 371 Date: Jun. 21, 2007

(30) Foreign Application Priority Data
Feb. 24, 2005 (KR) 1020050015228

(51) Int. Cl. G06F 15/16

(52) U.S. Cl. 358/1.15

(57) ABSTRACT

A method of transmitting/receiving fax data through internet and the system thereof are provided. The method of transmitting/receiving fax data through internet of the present invention comprises: receiving request for authentication from the first fax system, generating authentication information in response to the request, transmitting the generated authentication information to the first fax system and storing the same into authentication database—the first fax system encrypts fax data by using the received authentication information and transmitting the same to the second fax system—, receiving request for authentication confirmation from the second fax system, extracting authentication information corresponding to the fax receiving header information, and transmitting the extracted authentication information to the second fax system. According to the present invention, fax data authentication transmitted/received through internet makes it possible to enhance security and prevent spam fax.

### TECHNICAL FIELD

The present invention relates to transmitting/receiving facsimile (hereinafter, fax) data, and more particularly, to a method of transmitting/receiving fax data through internet network enabling to block spam fax data by authenticating on transmitting/receiving fax data.

### BACKGROUND ART

In the conventional transmitting fax data system, in which telephone line network is used, transmitting speed is low and the cost is high.

Meanwhile, due to the increase of internet users and the development of internet technology, communication systems through internet network have been proposed. One of the systems is a system and method of transmitting/receiving fax data through internet. Conventional methods of transmitting/receiving fax data are transmitting fax data through internet network mostly by connecting to a predetermined website of internet network or by using program for fax only

But conventional method of transmitting/receiving fax data through internet network is weak on security because of hacking and interrupting packet through internet. Besides, conventional method of transmitting/receiving fax data through internet network is free of charge or cheaper than when telephone line is used, so many spam fax data are produced.

Accordingly, there are needs for method of transmitting/receiving fax data through internet that intensifies security and blocks spam fax data.

### DISCLOSURE OF INVENTION

### Technical Problem

The present invention provides a system and method of transmitting/receiving fax data through internet to intensify security and prevent spam fax.

### Technical Solution

According to an aspect of the present invention, there is provided a method of transmitting/receiving fax data through internet, including (a) receiving a request for authentication of transmitting/receiving data from a first fax system; (b) generating a transmitting/receiving authentication information in response to the request for authentication; (c) transmitting the transmitting/receiving authentication information to the first fax system and storing the transmitting/receiving authentication information into a transmitting/receiving fax data authentication database, wherein the first fax system transmits a fax data which is encrypted using the received transmitting/receiving fax data authentication information to a second fax system; (d) receiving a request for authentication confirmation of transmitting/receiving fax data from the second fax system, wherein when the second fax system receives the fax data from the first fax system, the second fax system transmits the request for authentication confirmation of transmitting/receiving fax data comprising a header information of the fax data; (e) extracting transmitting/receiving data authentication information corresponding to the header information of the fax data from the transmitting/receiving fax data authentication database in response to the request for authentication confirmation of transmitting/receiving fax data; and (f) transmitting the transmitting/receiving data authentication information to the second fax system, which decrypts the fax data using the transmitting/receiving fax data authentication information.

According to another aspect of the present invention, there is provided a method of transmitting/receiving fax data through internet, including (a) receiving a request for authentication of transmitting/receiving fax data from a first fax system; (b) generating a pair of authentication keys including a first authentication key and a second authentication key; (c) transmitting the pair of authentication keys to the first fax system and storing the pair of authentication keys into a transmitting/receiving fax data authentication database, wherein the first fax system encrypts a fax data using the pair of authentication keys and transmits the encrypted fax data and the first authentication key to second fax system; (d) receiving a request for authentication confirmation of transmitting/receiving fax data from the second fax system, wherein when the second fax system receives the encrypted fax data from the first fax system, the second fax system transmits the request for authentication confirmation of transmitting/receiving fax data including a header information of the encrypted fax data; (e) extracting a second authentication key corresponding to the header information of the encrypted fax data from the transmitting/receiving fax authentication database in response to the request for authentication confirmation of transmitting/receiving fax data; and (f) transmitting the second authentication key to the second fax system, which decrypts the fax data using the first and second authentication keys.

The method of transmitting/receiving fax data through internet may further includes receiving a request for subscription from the first fax system; and storing a subscription information of the first fax system into a subscription information database in response to the request for subscription.

The method of transmitting/receiving fax data through internet may further includes receiving a request for fax transmitting proxy service from the first fax system; and receiving a fax data which is due to sent to the first fax system and storing the received fax data into a fax data database.

According to yet another aspect of the present invention, there is provided a method of transmitting/receiving fax data through internet, including (a) transmitting a transmitting fax data to a first fax system in response to a request of user; and (b) providing the user a receiving fax data received from a second fax system.

The step (a) comprises (a1) transmitting a request for authentication of transmitting/receiving fax data to a service server; (a2) receiving a transmitting/receiving fax data authentication information generated in response to the request for authentication; and (a3) encrypting the transmitting fax data by using the transmitting/receiving fax data authentication information received from the service server and transmitting the encrypted transmitting fax data to the first fax system through internet.

The step (b) comprises (b1) receiving the receiving fax data from the second fax system; (b2) transmitting a request for authentication confirmation of a transmitting/receiving fax data to the service server; (b3) receiving a transmitting/receiving fax data authentication information extracted in response to the request for confirmation of the transmitting/receiving fax data authentication; and (b4) decrypting the receiving fax data by using the transmitting/receiving fax data authentication information received in the step (b3).

According to yet another aspect of the present invention, there is provided a system of transmitting/receiving fax data through internet, including a fax system a transmitting fax data encrypted by using a first transmitting/receiving fax data authentication information, decrypting a receiving fax data by using a second transmitting/receiving fax data authentication information and providing a user with the decrypted fax data, when the receiving fax data received; and a service server being connected to the fax system through internet, generating and transmitting the first transmitting/receiving fax data authentication information in response to a request for authentication of transmitting/receiving fax data from the fax system, and providing the fax system the second transmitting/receiving fax data authentication information in response to a request for authentication confirmation of transmitting/receiving fax data.

The service server may further includes a fax system subscription/register unit managing subscription of the fax system in response to a request for subscription of the fax system and providing the fax system with a result of subscription disposal; a transmitting/receiving fax data authentication unit generating the first transmitting/receiving fax data authentication information in response to the request for authentication of transmitting/receiving fax data and providing the same to the fax system, and extracting parts or all of the second fax data authentication information from a transmitting/receiving fax authentication database in response to the request for confirmation of transmitting/receiving fax data authentication from the fax system and providing the same with the fax system; and a fax transmitting proxy service unit, receiving and storing a fax data which is due to be sent to the fax system when fax transmitting proxy service from the fax system is requested, and then transmitting the same to the fax system at required time.

In addition, the fax system may includes a subscription/register unit requesting subscription to the service server in response to a request of user and receiving a result of subscription disposal from the service server; a transmitting fax data unit encrypting the transmitting fax data by using the first transmitting/receiving fax data authentication information received from the service server as a result of the request for transmitting/receiving fax data authentication to the service server; and a receiving fax data unit decrypting the receiving fax data by using the second transmitting/receiving fax data authentication information received from the service server as a result of the request for confirmation of transmitting/receiving fax data authentication to the service server.

### ADVANTAGEOUS EFFECTS

As described above, by transmitting/receiving fax data authentication, it is possible to enhance the security on the fax data and shut off spam fax.

By transmitting/receiving fax data through internet network, it is possible to make fax data, i.e. transmitting and receiving fax data, database. As a result, it is much more easier to use and operate fax data with the database, and to reduce the use of supply compared to the existing fax transmitting/receiving through PSTN.

In addition, the transmitting speed is faster than transmitting/receiving fax data through telephone (PSTN) and fax fee also costs less.

### BRIEF DESCRIPTION OF THE DRAWINGS

FIG. 1 is a schematic diagram illustrating a method of transmitting/receiving fax data through internet according to an embodiment of the present invention;

FIG. 2 is a block diagram illustrating the structure of a service server according to an embodiment of the present invention;

FIG. 3 is a block diagram illustrating the structure of a fax system according to an embodiment of the present invention;

FIG. 4 is a flow chart, which shows a method of subscribing and registering to fax system according to an embodiment of the present invention;

FIG. 5 is a flow chart, which shows a method of transmitting/receiving fax data according to an embodiment of the present invention;

FIG. 6 is a flow chart, which shows a method of transmitting/receiving fax data according to another embodiment of the present invention;

FIG. 7 is a flow chart which shows a method of transmitting/receiving fax data according to still another embodiment of the present invention;

### BEST MODE FOR CARRYING OUT THE INVENTION

The attached drawings for illustrating preferred embodiments of the present invention are referred to in order to gain a sufficient understanding of the present invention, the merits thereof, and the objectives accomplished by the implementation of the present invention.

Hereinafter, the present invention will be described in detail by explaining preferred embodiments of the invention with reference to the attached drawings. Like reference numerals in the drawings denote like elements.

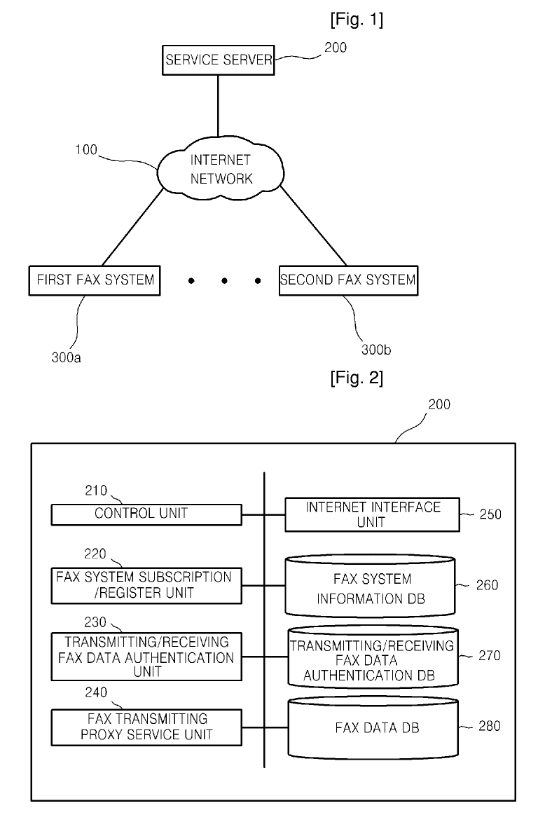

FIG. 1 is a schematic diagram illustrating a method of transmitting/receiving fax data through internet according to an embodiment of the present invention. Referring to FIG. 1, the method of transmitting/receiving fax data through internet according to an embodiment of the present invention applies to service server 200 and fax systems 300a and 300b connected to internet network 100.

Although FIG. 1 illustrates only two fax system, 300a and 300b, for convenience, it is possible that hundreds of fax systems can be connected to internet network. Reference No. 300 is indicating one of hundreds of fax system.

The fax system 300 performs similar functions to conventional fax, which transmits/receives fax data connected to PSTN. The fax system 300 may be configured to be operated loaded on a computer like PC (Personal Computer), therefore more various functions can be operated compared to conventional PSTN fax device. In detail, the fax system 300 may performs transmitting/receiving fax data function, user interface function, fax data management function based on directories such as sent massage box, received massage box and deleted massage box, a function of managing address book, a function of making out fax, and a function of editing fax image. More details of structure and functions of a fax system 300 are illustrated later.

The service server 200 performs subscription process in response to a request for subscription from the fax system 300 and authentication on the transmitting/receiving fax data transmitted by the fax system 300.

FIG. 2 is a block diagram illustrating the structure of a service server according to an embodiment of the present invention. Referring to FIG. 2, the service server 200 comprises a control unit 210, a fax system subscription/register unit 220, a transmitting/receiving fax data authentication unit 230, a transmitting fax data proxy service unit 240, a internet interface unit 250, a fax system information DB (database) 260, a transmitting/receiving fax data authentication DB 270 and fax data DB 280. Although FIG. 2 shows the service server 200 in which the databases 260, 270 and 280 are included, it is also possible to embody an exterior database system separated from the service server 200.

The fax system subscription/register unit 220 performs subscription of the fax system 300 in response to a request for subscription from the fax system 300. In order to transmitting fax data through internet, the fax system 300 should subscribe as a service subscriber to the service server 200. For that, the fax system 300 interfaces with the service server 200, and then applies for a subscription according to the pre-determined procedure. If the subscription is done, the fax system subscription/register 220 stores subscription information of the fax system 300 into a fax system information DB 260. Subscription information of fax system may include User ID, Password, fax number and production number etc.

The transmitting/receiving fax data authentication unit 230 performs authentication of fax data from a fax system to other fax system. Namely, when an authentication request for transmitting/receiving fax data is received from the fax system transmitting fax data, the transmitting/receiving fax data authentication unit 230 generates authentication information according to the predetermined algorithm in response to the authentication request.

The fax system to transmit fax data may transmit a signal requesting transmitting/receiving fax data authentication including fax transmitting header information, for example, transmitter information, receiver information, and fax data information, to the service server 200.

The transmitting/receiving fax data authentication unit 230 transmits the generated transmitting/receiving fax data authentication information to the fax system which requested for the authentication. In addition, the transmitting/receiving fax data authentication unit 230 stores the generated authentication information along with the received fax transmitting header information—transmitter information, receiver information, fax data information—to a transmitting/receiving data authentication DB 270.

When the transmitting/receiving fax data authentication unit 230 receives a request for authentication confirmation of transmitting/receiving fax data from the fax system 300 that received the fax data, the transmitting/receiving fax data authentication unit 230 also detects the information corresponding to the request for authentication confirmation from the transmitting/receiving fax data authentication DB and transmits some parts or all of the detected authentication information to the fax system requested the information.

The fax system 300 transmits a signal requesting for authentication confirmation of transmitting/receiving fax data including information, which is required for transmitting/receiving fax data authentication unit 230 detects transmitting/receiving fax data authentication information, for example, fax receiving header information such as transmitter information, receiver information, fax data information, and fax-receiving date to the service server 200.

The fax transmitting proxy service unit 240 deals with fax transmitting proxy service. The fax transmitting proxy service means that the service server 200 receives and stores temporary a fax data to be sent to a fax system, which is one of fax systems subscribed to a service server 200 and requested the proxy service, and transmit the fax data to a corresponding fax system.

This service is especially useful when a fax system is offline. For example, if the No. 2 fax system 300b is offline and an applicant for fax transmitting proxy service, fax data, due to sent to the No. 2 fax system 300b, is transmitted to a service server 200, and the service server 200 received the fax data and store it temporarily and sent the same to the No. 2 fax system which turns to online.

For that, when a fax transmitting proxy service unit 240 receives a request for transmitting proxy service from a fax system, it stores the request in fax system information DB 260 and also stores fax data sent from other fax system due to sent to the fax system already requested the service in fax data DB 280.

Further, when the fax transmitting proxy service unit 240 receives request for transmitting proxy service from the No. 2 fax system 300b, it detects corresponding fax data from the fax data DB 280 and transmits the No. 2 fax system 300b. And/or when the No. 2 fax system 300b is logged-on, it is possible that the service unit 240 detects and transmits corresponding fax data to the No. 2 fax system 300b to the No. 2 fax system 300b.

An internet interface unit 250 performs interface with internet network and the control unit 210 controls operation of the service server 200 generally.

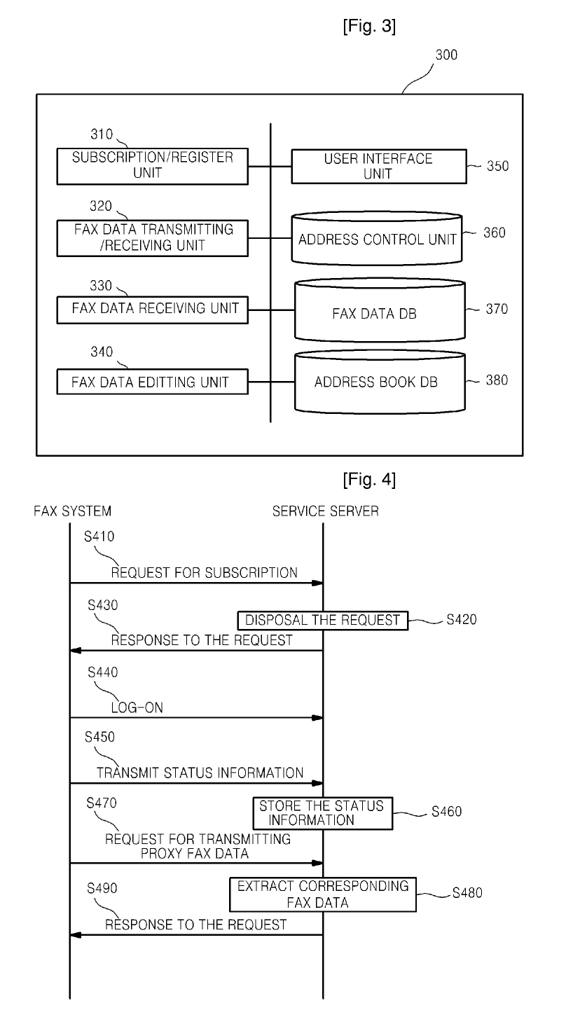

FIG. 3 is a block diagram illustrating the structure of the fax system 300 according to an embodiment of the present invention.

Referring to FIG. 3, the fax system 300 includes a subscription/register unit 310, a fax data transmitting/receiving unit 320, a fax data receiving unit 330, a fax data editing unit 340, a user interface unit 350, an address control unit 360, a fax data DB 370 and an address book DB 380.

The Subscription/register unit 310 transmits a request for subscription to the service server 200 in response to user's request. Also, according to established details and/or user's request, it logs on to the service server 200 automatically and transmits status of itself.

The fax data transmitting/receiving unit 320 transmits fax data directly to opposite fax system, and/or to the service server 300 in the case of opposite fax system being in the proxy service. Before sending fax data, it requests for transmitting/receiving fax data authentication to the service server 200, and receives transmitting/receiving fax data authentication information generated in the service server 200 in response to the request. And by using the received transmitting/receiving fax data authentication information, it encrypts transmitting fax data and sends the same to an opposite.

The fax data receiving unit 330 receives the fax data transmitted from opposite fax system or the service server 200. Also, the fax data receiving unit 330, for decrypting the receiving fax data, transmits a request for transmitting/receiving fax data authentication to service server and after receiving the transmitting/receiving fax authentication information from the service server 200, by using the authentication information decrypts the receiving fax data, and then make it possible to provide user with the receiving fax data through user interface unit 350.

The fax data editing unit 340 generates fax data according to user's request and edits the same. User interface unit 350 provides user interface function with user for selecting opposite receiver, making up fax data, sending the fax data, and also reading received fax data. The address control unit 360 stores receiver's information same to fax number of the opposite fax system in address book DB 380, and detects the receiver's information stored in address book DB 360.

The fax data DB 370 stores the fax data to be sent or sent, and the received fax data.

FIG. 4 is a flow chart shows a method of subscription and register of fax system according to an embodiment of the present invention. The procedure illustrates in FIG. 4 may be performed before fax transmitting/receiving fax data procedure.

Subscription/register procedure of the fax system is subscribing as a service user to service server and registering the fax system wherein.

Referring to FIG. 4, first of all, the fax system is set and connected to the service server and then requests for subscription (S410). The service server disposes of subscription in response to the request for subscription of fax system (S420), and informs the fax system of the result of subscription disposal (S430). For convenience of subscription procedure, user make up a subscription form which is provided by the service server and submit it to the service server. The subscription form includes subscriber ID, password, subscriber name, address and other information. Also, at the same time/after completing subscription, registration of fax system is completed. The fax system has own product number. When registering fax system, product number, fax number and so on are registered.

When subscription/register of fax system is done, it is possible for the fax system to perform transmitting/receiving fax data. But, it is desirable to log-on to the service server before actual transmitting/receiving fax data.

Regarding log-on, in detail, the fax system logs on the service server according to procedure for which user request, and/or it is possible to be set to log on the service server automatically at the same time the fax system (and/or fax system installed computer) is boot (S440).

When the fax system logs on the service server, it can transmit status of itself through separate step to the service server (S450).

If the status of the fax system is informing just log-on status to the service server, the status information can be transmitted to the service server without separate step (S450) through log-on stage (S440) and can be stored into the service server. But, if other information of the fax system besides status information—for example internet protocol address and etc.—needs to be transmitted, status information of the fax system needs to be transmitted to the service server through separated status information transmitting stage S450, and the service server may store the status information of the fax system in its inner part (S460).

In case of the fax system is an applicant for fax transmitting proxy service, after log-on to service server, it requests for transmitting proxy fax data (S470). Transmitting proxy fax data means the fax data received and stored by the service server for the applicant. In response to the request for transmitting proxy fax data from the fax system, the service server detects fax data corresponding to the fax system (S480) and transmits the same to fax system (S490).

Unlike illustrated in FIG. 4, when logged-on to the fax system, the service server checks whether the fax system requested the proxy service or not, and if the fax system requested the fax transmitting proxy service, the service server detects and provides the fax data received and stored by the service server, to the fax system.

### MODE FOR THE INVENTION

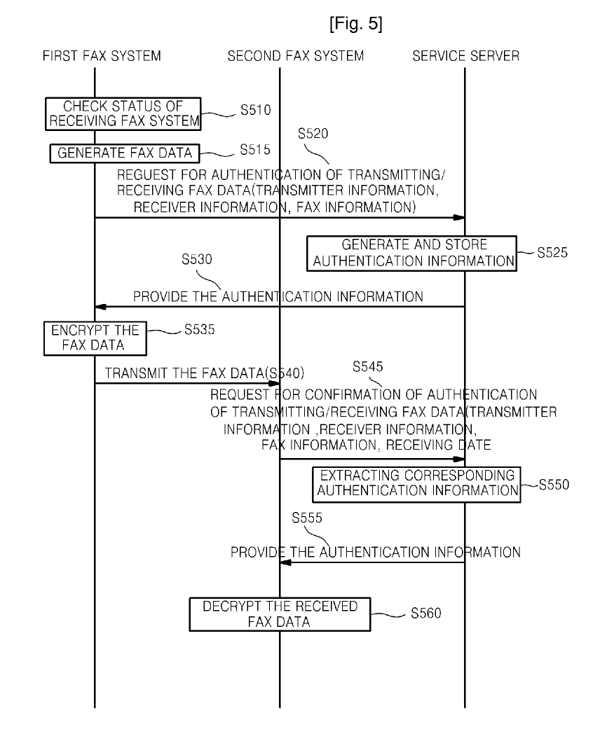

FIG. 5 is a flow chart showing a method of transmitting/receiving fax data according to an embodiment of the present invention. The service server 200 and the fax systems 300a, 300b illustrated in FIG. 1 can perform the method of transmitting/receiving fax data.

An embodiment of FIG. 5 is in the case of the first fax system transmitting fax data to the second fax system. Referring to FIG. 5, the first fax system checks status of receiving fax system (here, the second fax system), before transmitting the fax data to the second fax system (S510). For this, the first system may request the status of the receiving fax system directly to the second fax system and/or to the service server. In spite of the request for status directly to the second fax system, if the status of the second fax system is not available, the first fax system may request for the status of the second fax system to the service server again. In case that the fax system use variable Internet Protocol Address, the variable Internet Protocol Address of the receiving fax system can be obtain by receiving of the fax system status.

The first fax system generates fax data for transmitting to the second fax system (S515), which may happen before checking of receiving fax system status (S510). The second fax system is supposed to be online status, as a result of checking of the second fax system status in this example embodiment.

Next, the first fax system requests for authentication of transmitting/receiving fax data to the service server (S520). An example embodiment of the first fax system transmits a request signal for transmitting/receiving fax data authentication including fax transmitting header information—for example, transmitter information, receiver information, and fax information—. Here the fax information may be a title of fax data.

The service server generates authentication information according to the pre-determined algorithm in response to the request for transmitting/receiving fax data authentication from the first fax system, and stores the same into transmitting/receiving fax authentication DB (S525), and then transmits the same to the first fax system (S530).

The first fax system encrypts the fax data by using the authentication information received from the service server (S535) and transmits the same to the second fax system (S540).

The second fax system requests for confirmation of transmitting/receiving fax data authentication to the service server when receives the fax data from the first fax system (S545). When the second fax system requests for confirmation of transmitting/receiving fax data authentication, it is preferable that the second fax system transmits a request signal for confirmation of transmitting/receiving fax data authentication including fax receiving header information—for example, transmitter information, receiver information, fax information, receiving date and etc.—.

The service server detects authentication information corresponding to the fax receiving header information, in response to the request for confirmation of transmitting/receiving authentication received from the second fax system, from transmitting/receiving fax data authentication DB (S550), and provide the detected information to the second fax system (S555).

The second fax system decrypts the fax data received from the first fax data by using the authentication information received from the service server, and provides the same to user (S560).

As described above, according to an example embodiment of the present invention, the first fax system, transmitting fax data, encrypts and transmits the fax data using the authentication information received from the service server, the second fax system, receiving the fax data, should receive the same authentication information as one that used in encrypting the fax data from the service server for fully accomplishing its duty. Accordingly, safety on transmitting fax data is enhanced and disturbing spam fax is excluded.

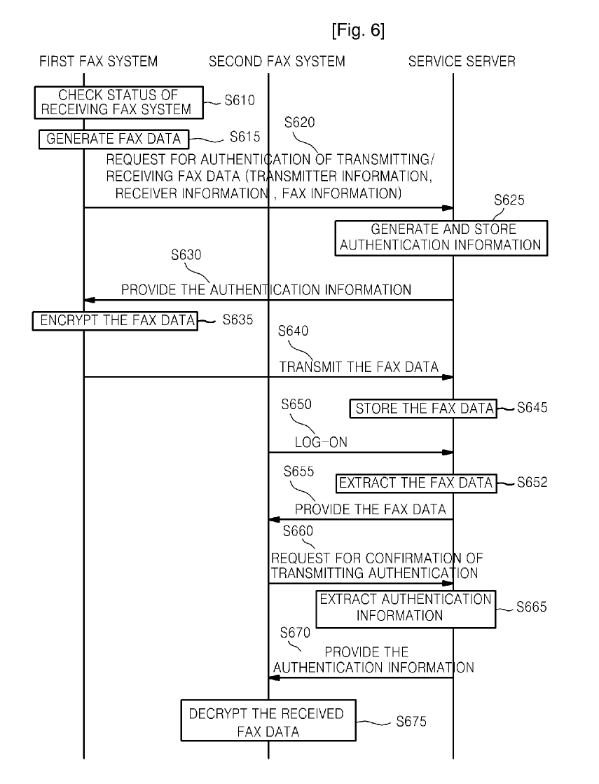

FIG. 6 is a flow chart showing a method of transmitting/receiving fax data according to another embodiment of the present invention, which may be performed by the service server 200 and the fax systems 300a, 300b, illustrated in FIG. 1.

An example embodiment of FIG. 6 shows that the first fax system transmits fax data to the second fax system using fax data transmitting proxy service. Referring to FIG. 6, before the fax data is transmitted from the first fax system to the second fax system, the first fax system checks status of receiving fax system (here is the second fax system) (S610) and generates fax data (S615). These steps of S610 and S615 are identical to steps illustrated in FIG. 5 (S510, S515), so for fear of repetition, detail description regarding these steps (S610, S615) is omitted. But, in this embodiment, it is supposed that the second fax system is not on-line and has already requested the fax data proxy service to the service server.

Then, as a result that the first fax system checks status of the second fax system through directly the second fax system, or through service server, it can detect that the second fax system is not on-line and requested the proxy service, and so it transmits the fax data to the service server not the second fax system.

Before transmitting the fax data, the first fax system requests transmitting/receiving fax data authentication to the service server (S620). The service server generates authentication information in response to the request for authentication from the first fax system according to the predetermined algorithm, and stores the generated information into transmitting/receiving data authentication DB (S625). And also the service server transmits the generated information to the first fax system (S630). These steps are also identical to steps S520, S525, S530 of FIG. 5.

The first fax system encrypts the fax data using the authentication information received from the service server (S635), and transmits the same to the service server (S640). It is necessary for the first fax system to inform the service server of identity of fax system by transmitting transmitter information, receiver information, fax information and etc.

The service server stores the fax data into the fax data DB received from the first fax system (S645).

After the step S645, when the second fax system logs on the service server (S650), the service server extracts the fax data to be sent to the second fax system from the fax data DB (S652), and transmits the same to the second fax system (S655). For this, as described above regarding FIG. 4, after the second fax system being log-on, the second fax system can request to receive the transmitting proxy fax data from the service server, or the service server can provide the fax data corresponding to the second fax system after checking whether status of request for fax transmitting proxy service and fax data to be transmitted or not.

When the second fax system receives the fax data from the service server, it requests for confirmation of transmitting/receiving fax data authentication to the service server (S660). At this time, it is preferable for the second fax system to send a request signal for confirmation of transmitting/receiving fax data authentication including fax receiving header information—for example, transmitter information, receiver information, fax information, receiving date—to the service server.

The service server extracts authentication information corresponding to the fax receiving header information from the transmitting/receiving fax authentication DB, in response to the request for confirmation of transmitting/receiving fax data received from the second fax system. And service server provides the same with the second fax system (S675).

The second fax system decrypts the fax data received from the first fax system using the authentication information received from the service server, and provides the same with user (S675).

Unlike illustrated in FIG. 6, when the service server transmits the fax data to the second fax system (S655), it can also provide corresponding authentication information with the second fax system.

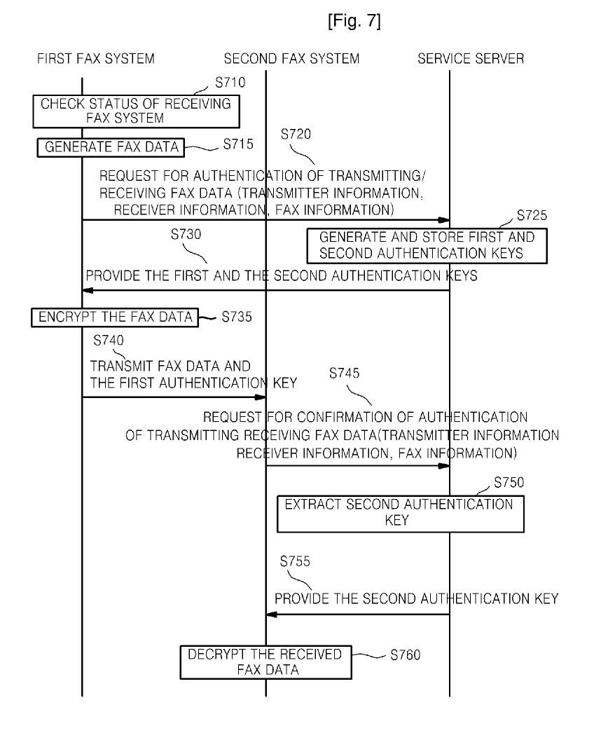

FIG. 7 is a flow chart showing method of transmitting/receiving fax data according to yet another example embodiment, which is also accomplished by the service server 200 and the fax systems 300a, 300b illustrated in FIG. 1. An example embodiment illustrated in FIG. 7 is similar to one of FIG. 5. Accordingly, detail explanation of FIG. 7 is omitted, except the fact that authentication information used for transmitting/receiving fax data is a pair of keys consists of the first authentication key and the second authentication key.

Namely, the service server generates the first and second authentication keys (a pair) according to the predetermined algorithm, in response to request of transmitting/receiving fax data authentication from the first fax system, and stores the generated pair of keys in the transmitting/receiving fax data DB S725, and also transmits the same to the first fax system.

The first fax system encrypts fax data using the first and the second authentication keys (a pair of keys) received from the service server, and transmits the encrypted fax data along with the first authentication key to the second fax system (S740).

And after then, the second fax system requests for confirmation of transmitting/receiving fax data authentication (S745). When requesting transmitting/receiving fax data authentication, the second fax system is preferable to transmit a request signal of transmitting/receiving fax authentication including fax receiving header information—for example, transmitter information, receiver information, fax information, receiving date, etc—.

The service server extracts the second authentication key corresponding to the fax receiving header information from transmitting/receiving fax data authentication DB (S750), and transmits the same to the second fax system (S755). The second fax system decrypts the encrypted data received from the first fax system using the first authentication and the second authentication each received from the first fax system and the service server (S760).

The method of transmitting/receiving fax data using the first and the second authentication keys (a pair of keys) illustrated in FIG. 7 may be applied to the fax transmitting proxy service. In other words, like example embodiment illustrated in FIG. 6, fax transmitting is done through the service server, but when authenticating of fax transmitting/receiving, a pair of keys may be used like FIG. 7.

Also, fax data may include fax text modification check unit to check fax text is modified or not. In other words, the fax data may include the fax text and the fax text modification check unit. The fax text modification check unit is used in sensing the fax text is modified or not. The fax text modification check unit may include special characters, special patterns, holograms and etc. If receiving fax data has no a fax text modification check unit or has a damaged one, it is judged that the fax text is forged or modified. Therefore, the fax text modification check unit is a kind of preventing forgery data, so legal effect on fax data transmitted through internet may be allowed.

Although in the above-illustrated example embodiments, for convenience, it is illustrated that the first fax system 300a of FIG. 1 transmits fax data, and the second fax system 300b of FIG. 1 receives the fax data, not only the first and the second fax systems 300a, 300b but also other fax systems not illustrated in figures have transmitting/receiving fax data function. And the first fax system 300a of FIG. 1 or other fax systems not illustrated in figures besides the second fax system have fax transmitting proxy service function. Example embodiments of the present invention are just examples, and who has common sense in concerned field may understand that various transformation from the examples and other embodiments equal are possible. Therefore, protection area of the present invention should be decided only by attached claims.

### INDUSTRIAL APPLICABILITY

As described above, according to the present invention, authentication of transmitted/received fax data make it possible to block spam fax and to enhance security on fax data.

Also, according to the present invention, it is possible to reduce waste of suppliances (paper, print cartridges, and etc.), and to make controlling and using fax data much more easy due to fax data DB, and further transmitting speed is high and telephone rate cost less compared to traditional method of transmitting/receiving fax data through PSTN network.

1. A method of transmitting/receiving fax data through internet, the method comprising:
(a) receiving a request for authentication of transmitting/receiving data from a first fax system;
(b) generating a transmitting/receiving authentication information in response to the request for authentication;
(c) transmitting the transmitting/receiving authentication information to the first fax system and storing the transmitting/receiving authentication information into a transmitting/receiving fax data authentication database, wherein the first fax system transmits a fax data which is encrypted using the received transmitting/receiving fax data authentication information to a second fax system;
(d) receiving a request for authentication confirmation of transmitting/receiving fax data from the second fax system, wherein when the second fax system receives the fax data from the first fax system, the second fax system transmits the request for authentication confirmation of transmitting/receiving fax data comprising a header information of the fax data;
(e) extracting transmitting/receiving data authentication information corresponding to the header information of the fax data from the transmitting/receiving fax data authentication database in response to the request for authentication confirmation of transmitting/receiving fax data; and
(f) transmitting the transmitting/receiving data authentication information to the second fax system, which decrypts the fax data using the transmitting/receiving fax data authentication information.

2. A method of transmitting/receiving fax data through internet, the method comprising:
(a) receiving a request for authentication of transmitting/receiving fax data from a first fax system;
(b) generating a pair of authentication keys including a first authentication key and a second authentication key;
(c) transmitting the pair of authentication keys to the first fax system and storing the pair of authentication keys into a transmitting/receiving fax data authentication database, wherein the first fax system encrypts a fax data using the pair of authentication keys and transmits the encrypted fax data and the first authentication key to second fax system;
(d) receiving a request for authentication confirmation of transmitting/receiving fax data from the second fax system, wherein when the second fax system receives the encrypted fax data from the first fax system, the second fax system transmits the request for authentication confirmation of transmitting/receiving fax data including a header information of the encrypted fax data;
(e) extracting a second authentication key corresponding to the header information of the encrypted fax data from the transmitting/receiving fax authentication database in response to the request for authentication confirmation of transmitting/receiving fax data; and
(f) transmitting the second authentication key to the second fax system, which decrypts the fax data using the first and second authentication keys.

3. The method of claim 1, further comprising:
(g) receiving a request for subscription from the first fax system; and
(h) storing a subscription information of the first fax system into a subscription information database in response to the request for subscription.

4. The method of claim 1, further comprising:
(g) receiving a request for fax transmitting proxy service from the first fax system; and
(h) receiving a fax data which is due to sent to the first fax system and storing the received fax data into a fax data database.

5. The method of claim 4, further comprising:
(i) receiving a request for transmitting proxy fax data from the first fax system; and
(j) extracting a fax data corresponding to the first fax system from the fax data database in response to the request for transmitting proxy fax data from the first system and transmitting the extracted fax data to the first system.

6. The method of claim 4, further comprising:
(i) extracting and transmitting a fax data corresponding to the first fax system from the fax data database to the first fax system, when the first fax system is logged-on.

7. The method of claim 1, wherein the fax data includes fax data text and modification checking unit thereof, which is used to sense whether fax data is modified or not.

8. A computer readable recording medium for recording a program for executing the method of claim 1.

9. A method of transmitting fax data through internet, the method comprising:
(a) transmitting a transmitting fax data to a first fax system in response to a request of user; and
(b) providing the user a receiving fax data received from a second fax system, wherein the step (a) comprises:
(a1) transmitting a request for authentication of transmitting/receiving fax data to a service server;
(a2) receiving a transmitting/receiving fax data authentication information generated in response to the request for authentication; and
(a3) encrypting the transmitting fax data by using the transmitting/receiving fax data authentication information received from the service server and transmitting the encrypted transmitting fax data to the first fax system through internet, and wherein the step (b) comprises:
(b1) receiving the receiving fax data from the second fax system;
(b2) transmitting a request for authentication confirmation of a transmitting/receiving fax data to the service server;
(b3) receiving a transmitting/receiving fax data authentication information extracted in response to the request for confirmation of the transmitting/receiving fax data authentication; and
(b4) decrypting the receiving fax data by using the transmitting/receiving fax data authentication information received in the step (b3).

10. The method of claim 9, further comprising:
(c) transmitting a request for subscription to the service server;
(d) receiving a disposal result of the request for subscription from the service server

11. The method of claim 9, comprising:
(a4) transmitting an inquiry of the status of the first fax system to the service server or the first fax system before the step (a3).

12. A computer readable recording medium for recording a program for executing the method of claim 9.

13. A system of transmitting/receiving fax data through internet, comprising:
a fax system a transmitting fax data encrypted by using a first transmitting/receiving fax data authentication information, decrypting a receiving fax data by using a second transmitting/receiving fax data authentication information and providing a user with the decrypted fax data, when the receiving fax data received; and
a service server being connected to the fax system through internet, generating and transmitting the first transmitting/receiving fax data authentication information in response to a request for authentication of transmitting/receiving fax data from the fax system, and providing the fax system the second transmitting/receiving fax data authentication information in response to a request for authentication confirmation of transmitting/receiving fax data.

14. The system of transmitting/receiving fax data of claim 13, wherein the service server comprises:
a fax system subscription/register unit managing subscription of the fax system in response to a request for subscription of the fax system and providing the fax system with a result of subscription disposal;
a transmitting/receiving fax data authentication unit generating the first transmitting/receiving fax data authentication information in response to the request for authentication of transmitting/receiving fax data and providing the same to the fax system, and extracting parts or all of the second fax data authentication information from a transmitting/receiving fax authentication database in response to the request for confirmation of transmitting/receiving fax data authentication from the fax system and providing the same with the fax system; and
a fax transmitting proxy service unit, receiving and storing a fax data which is due to be sent to the fax system when fax transmitting proxy service from the fax system is requested, and then transmitting the same to the fax system at required time.

15. The system of transmitting/receiving fax data of claim 14, wherein the fax system comprises:
a subscription/register unit requesting subscription to the service server in response to a request of user and receiving a result of subscription disposal from the service server;
a transmitting fax data unit encrypting the transmitting fax data by using the first transmitting/receiving fax data authentication information received from the service server as a result of the request for transmitting/receiving fax data authentication to the service server; and
a receiving fax data unit decrypting the receiving fax data by using the second transmitting/receiving fax data authentication information received from the service server as a result of the request for confirmation of transmitting/receiving fax data authentication to the service server.

16. The method of claim 2, further comprising:
(g) receiving a request for subscription from the first fax system; and
(h) storing a subscription information of the first fax system into a subscription information database in response to the request for subscription.

17. The method of claim 2, further comprising:
(g) receiving a request for fax transmitting proxy service from the first fax system; and
(h) receiving a fax data which is due to sent to the first fax system and storing the received fax data into a fax data database.

18. The method of claim 17, further comprising:
(i) receiving a request for transmitting proxy fax data from the first fax system; and
(j) extracting a fax data corresponding to the first fax system from the fax data database in response to the request for transmitting proxy fax data from the first system and transmitting the extracted fax data to the first system.

19. The method of claim 17, further comprising:
(i) extracting and transmitting a fax data corresponding to the first fax system from the fax data database to the first fax system, when the first fax system is logged-on.

20. The method of claim 2, wherein the fax data includes fax data text and modification checking unit thereof, which is used to sense whether fax data is modified or not.

21. A computer readable recording medium for recording a program for executing the method of claim 2.

22. A computer readable recording medium for recording a program for executing the method of claim 10.
